(19) United States
(12) Patent Application Publication
(10) Pub. No.: US 2007/0021999 A1
(43) Pub. Date: Jan. 25, 2007

(54) Labor and transaction management system and method

(76) Inventors: Michael James Whalen, Cincinnati, OH (US); Jaison Manian, Mason, OH (US); Kaliyappa Gounder Rajendran, Westerville, OH (US); Kenneth Raymond Douglas, Fairfield, OH (US); David Edward Williams, West Chester, OH (US); Matthew David Garay, West Chester, OH (US); Donald Joseph Boyle, Cincinnati, OH (US); Byron William Page, Malibu, CA (US); Samuel D. Dantzler III, Roanoke, VA (US); Alex John Robinson, Mason, OH (US); David T. Baker, Dallas, TX (US)

Correspondence Address: THOMPSON HINE L.L.P., P.O. BOX 8801, DAYTON, OH, 45401-8801, US

(21) Appl. No.: 11/184,559

(22) Filed: Jul. 19, 2005

(51) Int. Cl. G07G 1/00

(52) U.S. Cl. 705/10

(57) ABSTRACT

A method for generating labor requirements including the step of providing a plurality of sales models based upon historical data, where each sales model is associated with a store within an enterprise. A sales model is selected and a sales forecast is generated based upon the selection of at least one sales model from the plurality of sales models. Workload standards and labor rates are obtained and a labor forecast for the store is generated based upon the sales forecast, the workload standards and the labor rates. Store level users are able to generate the labor requirements.

### FIELD OF INVENTION

A system for predicting workload at various time intervals and on a daily basis and for scheduling labor on a store-by-store basis through an enterprise-wide system is disclosed. The system can be used to create and predict budgets and monitor store forecasts and sales.

### BACKGROUND OF THE INVENTION

A number of systems have been developed for retail outlets or stores to manage and schedule their labor requirements. Planning, scheduling and managing personnel in an environment in which there is a varying workload by the time of the day and day of the week, requires periodic monitoring and dynamic management of a number of inter-related and inter-dependent resources. Moreover, in a store, the management of labor resources and the factors involved with special holidays, peak shopping times, and the like requires additional factors to be considered.

As used herein, a store can be a retail outlet, wholesale outlet, restaurant, branch office or other physical location where transactions involving goods or services occur between the customer and the enterprise. The store is accountable for meeting budgetary commitments on a regular basis and has profit and loss accountability to the entire enterprise. Stores may be subdivided into smaller sections or departments to more effectively control and track their revenues and expenses. Examples of departments for a typical large retail store or what is generally called a superstore may include a men's clothing department, women's clothing department, toy department, consumer electronics department, grocery department, sporting goods department, automotive department, pharmacy department, furniture department, shoe department, alcoholic beverages department, housewares department, baby department and the like. Examples of departments within a typical grocery store can include the meat department, pharmacy department, grocery department, produce department, frozen foods department and the like. Departments are frequently sub-divided to facilitate better control over the activities in the department. For example, the meat department may be subdivided into seafood, packaged meats and fresh cut meats. The pharmacy department may have a separate subdivision for prescription drugs and over the counter preparations.

An enterprise comprises a number of stores that may be grouped by geographical or corporate characteristics, such as divisions. Divisions may be defined by geographical location, type of store, e.g. a convenience store or a superstore, or demographics, e.g. rural, urban or suburban. In addition, the demographic profiles of store customers and shopping patterns may be used to group stores (e.g. a suburban middle class neighborhood or a suburban upper income neighborhood). Divisions may be further divided into zones. Zones are subsets of divisions composed of related stores. Zones may be determined on a geographical basis, such as zip codes.

For each store, the appropriate number and type of workers must be scheduled. Workers can include a variety of personnel such as cashiers, sales personnel and courtesy clerks, who help the customer with the purchases and bag or package the purchases. Store management must also schedule the personnel necessary to the operation of each department, the personnel necessary to stock the items in each department as well as scheduling the managers themselves.

As evidenced by the variety of people and the multiple locations, departments, stores and divisions, the logistics involved in coordination of the labor requirements for an enterprise is very complex. A labor management system that takes into account various factors including the day of the week, the beginning or end of the month, holidays and other such variables and provides both transaction and labor predictions is needed. A system that allows review of transactions, labor predictions and data sharing throughout an enterprise is also needed. There is a further need for a system which allows users at all levels of the enterprise to generate and compare alternative transaction and labor predictions based upon differing possible management decisions.

### BRIEF SUMMARY OF THE INVENTION

In one embodiment, the invention is a method for generating labor requirements including providing a plurality of sales models based upon historical data, where each sales model is associated with a store within an enterprise. A sales model is selected and a sales forecast is generated based upon the selection of at least one sales model. Workload standards and labor rates are obtained and a labor forecast for the store is generated based upon the sales forecast, the workload standards and the labor rates. Store level users are able to generate the labor requirements.

### BRIEF DESCRIPTION OF THE SEVERAL VIEWS OF THE DRAWING

While the specification concludes with claims particularly pointing out and distinctly claiming the present invention, it is believed that the present invention will be better understood from the following description in conjunction with the accompanying drawing figures, in which like reference numerals identify like elements, and wherein:

FIG. 1A is a schematic diagram of data flow between enterprise personnel and an embodiment of the present invention;

FIG. 1B is a schematic diagram of the data flow within an embodiment of the present invention;

FIG. 2 is a flowchart illustrating the process of generating and updating models;

FIG. 3 is a flowchart illustrating the process of generating a labor forecast;

FIG. 4 is a flowchart illustrating the process of generating forecasts;

FIG. 5 is an illustration of an embodiment of the system architecture of the present invention.

### DETAILED DESCRIPTION OF THE INVENTION

For the purposes of describing one embodiment of the present invention, this description will discuss a large retail grocery enterprise. This embodiment is merely exemplary in nature and is in no way intended to limit the invention, its application, or uses and alternatively this invention can be used in most any retail, wholesale or service enterprise.

I. Brief Summary

The system and method developed herein, through the collection of employee data, transaction analysis, and inventory data and the recognition of special events, enables the retail managers as well as executives to manage the day-to-day scheduling of labor, to predict additional labor requirements, and to monitor and forecast profits and profitability of a store or the entire enterprise. The system may be used to track sales and labor forecasting profit and loss, highlight any variations from the established standards for the store, plan budgets and improve productivity and profitability. In one embodiment, users at all levels within the enterprise may dynamically generate multiple forecasts dependent upon events as well as alternative management decisions. An event, as used herein, is an occurrence with a distinct sales trend that has significance to sales and labor forecasting.

To predict future labor requirements, the system generates models from historical data that reflect conditions at the stores within the enterprise. It has been recognized that every day is not the same in certain retail markets, especially in grocery and super stores. Therefore, historical data can be used to create a set of models for each store. Multiple models are created to reflect different in store conditions. For example, one model may be created for weekdays; a second model may be created using historic data collected during the weekends.

In particular, the system may create a sales model that reflects sales or transactions in a specific store during the course of a day. The sales model may contain transaction information broken down into small intervals, such as fifteen minutes. Multiple sales models may be created for each store to reflect different sales conditions. For example, one sales model may be created to reflect sales in the days leading up to a holiday or other special days. Another sales model may be created for the day after Thanksgiving. If the local workers are paid at the end of the month, the number and type of transactions for the last day of the month and the first few days of the next month may differ from those of the days in the middle of the month. An additional sales model may be generated to reflect those differences. In one embodiment, a set of sales models is created for each store in the enterprise. This set of models may be stored at the enterprise level, such that the models and the information contained therein may be available to management throughout the enterprise. Store managers may be able to copy and utilize data and models generated by similar stores within the enterprise.

Multiple sales models may be combined and adjusted to create a forecast of the sales for a store for a specific period of time in the future. Sales forecasts may include Scheduler commercially available from Kronos Incorporated of Chelmsford, Mass., to generate employee schedules.

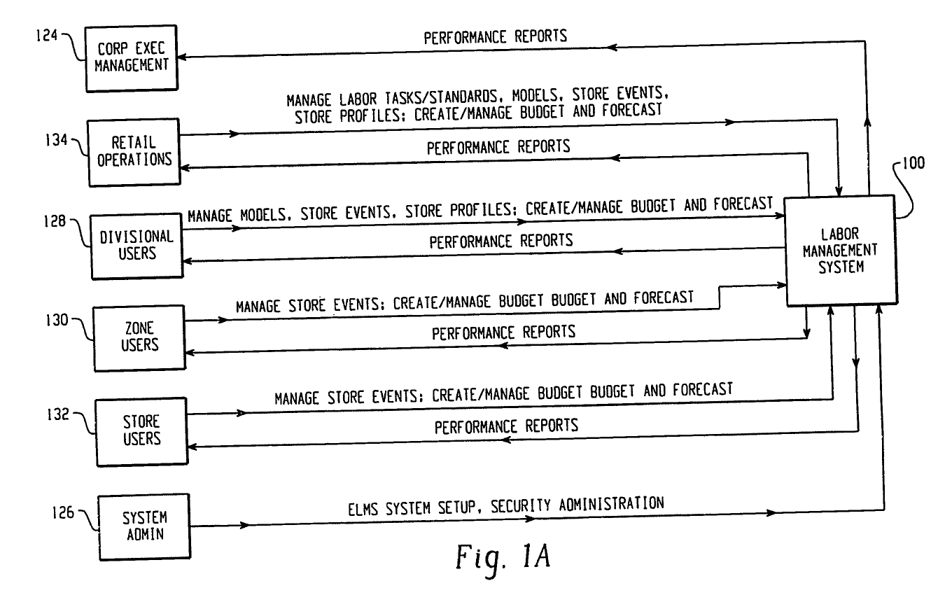

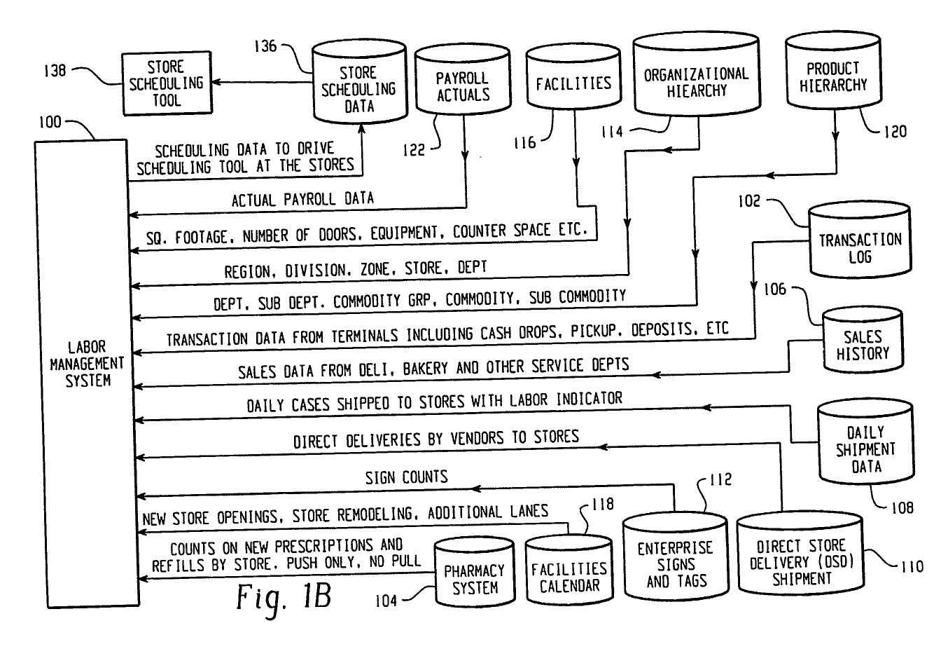

Referring now to FIGS. 1A and 1B, in one embodiment, the system 100 pulls data from a wide variety of data sources to forecast sales and labor requirements at various levels in a retail enterprise. Much, if not all, of the data utilized by the system is of the sort typically collected by stores and is likely to be stored by the enterprise. In one embodiment, the data is stored in a series of databases maintained at the enterprise level. However, those skilled in the art will realize that the data utilized by the system may be imported from a variety of software applications, databases or other data storage systems.

To generate comprehensive forecasts of the labor requirements for a particular store, the system utilizes historical transaction data from that store. Transaction data, as used herein, is information related to transactions or sales by the enterprise, as described in further detail below. In a large retail grocery enterprise, the system 100 may receive transactional data from a number of sources such as a transaction log database 102, a pharmacy database 104, a service sales history database 106, as well as transactions from the cash register of a store café and the like. A transaction log database 102 may include information regarding each transaction processed at each of the cash registers located at the individual checkout lanes. A grocery enterprise may well have a separate computer system for a pharmacy. In which case, a separate pharmacy database 104 may provide sales information from an in-store pharmacy to the labor management system including such information as the number of new prescriptions as well as refill counts filled by the pharmacy. A service sales history database 106 may include sales data from the deli, bakery, and other such departments which have special labor requirements due to additional customer service required for such sales. While transaction data provides the system 100 with critical information regarding labor requirements over the course of a day, additional information is necessary to predict the total labor requirements for a store.

In one embodiment, the system 100 may import stocking information from a number of databases. Such stocking information databases may include a daily shipment database 108, a direct store delivery (DSD) shipment database 110, a sign or tag database 112. The daily shipment database 108 may include information regarding cases of goods shipped to stores from a warehouse on a daily basis. A DSD shipments database 110 may include information regarding shipments delivered by vendors directly to the store. A sign and tag database 112 may contain information regarding the signs and labels posted proximate to items in the store. These signs must be continually updated to reflect changes in price, special sales and the like.

In one embodiment, the system 100 may also include information regarding the organization and composition of stores and divisions within the enterprise. The system 100 may receive information from a variety of software systems and databases including an organizational hierarchy database 114, a facilities database 116, a facility calendar database 118, a product hierarchy database 120, and a payroll database 122. The system 100 may import data from the organizational hierarchy database 114 regarding the structure and hierarchy of the divisions, zones, stores and departments that make up the enterprise. This hierarchical information allows the system 100 to combine the appropriate store information to generate predictions or reports on a zone, division or enterprise wide scale. The facilities database 116 may include information regarding the equipment, size, number of doors and the like for each of the stores within the enterprise. The store facilities may affect the time required to perform various tasks and therefore the labor requirements of the store. The system may import information regarding new store openings, and store remodeling or other changes to existing stores from the facility calendar database 118. Such modifications to facilities may impact labor and sales predictions. The product hierarchy database 120 may include information regarding the types of items contained within each department, subdepartment and the like. The information may be combined with information regarding the items sold during the course of a day to determine the items sold per department. This gives an indication of the labor required on a per department basis. The system 100 may also import payroll data for each store from the payroll database 122. The system 100 may utilize the payroll data to predict labor costs and generate budgets.

In one embodiment, the system 100 is able to receive and process a tremendous amount of information from a wide variety of sources. The system 100 may then utilize this information to generate highly accurate and comprehensive sales and labor forecasts. The system 100 may be able to dynamically communicate this information to users at all levels of the enterprise. As illustrated in FIG. 1A, employees of many different levels within the enterprise may interact with the system 100. At the top level, corporate executive management 124 may only wish to receive performance reports comparing forecast sales and costs generated by the system to actual sales and costs at varying levels of detail. The system administrators 126 at the enterprise level are necessary to maintain and update the system 100. Retail operations, divisional, zone and store users 134, 128, 130 and 132 may each utilize the system to create and manage budgets and forecasts as well as receiving performance reports. Such users may input store information scheduling upcoming events, update the store profiles and the like. Retail operations 134 may oversee performance for the entire enterprise, monitoring divisions and developing and approving best practices for the enterprise.

The system 100 may be designed so that each user may make changes affecting only the store or stores within their authority. For example, while a store user 142 may have the ability to make changes to the store profile of their store, but be unable to modify the profile of another store. Similarly, a divisional user 138 may have the ability to make changes to any or all of the stores within his or her division, but be unable to modify store information for a store within another division. Any of the users is able to receive performance reports tracking actual performance of a store or group of stores.

The labor requirement information may also be utilized to schedule the workers at a store. In one embodiment, the labor requirements for each store in the enterprise are saved to a store scheduling database 130. The individual stores may then access the database, retrieve the information and generate employee schedules. In one embodiment, the labor requirements may be imported directly into a software scheduling tool 132.

II. Model Development

The system 100 may use modeling to process the abundance of data and to improve forecasting accuracy. The use of models to simulate store conditions, rather than raw, bulk data, minimizes the amount of storage required by the system 100. Using models also reduces the affects of anomalous data and increases system accuracy. In one embodiment, models are created by averaging and smoothing the historical data, which prevents unusual events from skewing the projected sales and labor costs. Consequently, the models may provide a more accurate prediction of future conditions than bulk, raw historical data.

The system may use multiple types of models to represent or simulate different aspects of the store. Such models may include shipment models, item preparation models, pharmacy models, pricing models, sales models and the like. Shipment models, as used herein, reflect the receipt of shipments of items at a store. Such models may be generated based upon historical data regarding the quantity and type of items delivered to the store as well as the timing of such deliveries. Shipments may include deliveries to the store from an enterprise warehouse as well as deliveries directly to the store by vendors. An item preparation model reflects or simulates preparation required for various items before the items may be sold. Examples of item preparation include the baking of breads, cakes and the like in the bakery department, as well as preparation of salads and other prepared foods at the deli counter. If the store contains a pharmacy, the system may also include a pharmacy model generated from historical data regarding number and type of prescriptions filled and the like. The system may also include a pricing model that reflects the number and type of signs or tags created or updated in the store over the course of a day. In a store such as a grocery store, new products are continually added and prices change on a daily basis which can reflect sales, special promotions, or simply normal business practices. Sales models may be created based upon transaction data and are intended to reflect the number and type of transactions occurring in fifteen-minute intervals through the course of a day.

In an alternate embodiment, the system may include transaction models. In this embodiment, the sales models may contain such information as the number of customers, the number of items and the transaction models may include information such as the number of items scanned during each transaction and the type of the transaction (e.g. cash, check, credit card, gift card and the like). In this embodiment the sales models and transaction models would be paired such that each sales model would have a single corresponding transaction model.

In one embodiment, the system may use historical data collected over a period of time to create a set of each type of model for every store in the enterprise. Separate models may be developed for different days of the week, different periods of time within the month, the holidays and the like. In one embodiment, the set of models for a store will be created using only historical data collected from that store. If data is not yet available for a particular store, the system may utilize data collected at a similar store to generate an initial set of models. The initial set of models may be adjusted as data is collected for that store.

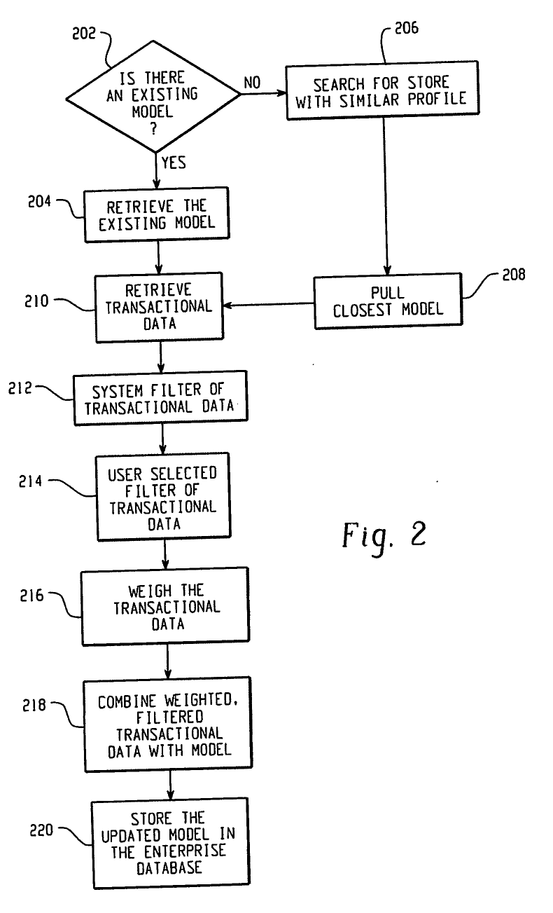

Referring now to FIG. 2, a system administrator 136 may direct the system 100 to create a new model for a store or update an existing model. Model creation may be limited to certain users or classes of users, such as system administrators. For the purposes of this discussion, a sales model will be updated or generated. However, all of the different types of models are generated using the same process, only the data inputs vary. Each new model will be associated with a specific set of store conditions, such as a day of the week and time of day. Once created, models may be continually updated and adjusted to increase their accuracy by including the most recent data from the store. In one embodiment, the system 100 automatically updates existing models or generates a set of models for a new store on a daily or weekly basis. The system first determines whether there is an existing model for the store under the specified store conditions at step 202. If a model for the given store conditions already exists for this store, the system will retrieve the appropriate model at step 204.

If no such model for the store exists, the system will search for a store for a similar store profile. As used herein, a store profile is a set of common attributes such as the departments present within the store, the geographic region in which the store is located, the demographics of the store customers and the like. In one embodiment, the system 100 may include a set of standard store profiles or templates for store profiles. In such an embodiment, each individual store would be associated with a standard store profile. The system would have access to information specifying which standard store profile or template is applicable for each store, as well as information specifying any exceptions or variances from the standard profile or template. The set of standard profiles may include profiles for a warehouse, a supercenter, a convenience store or demographics, e.g. rural, urban or suburban and the like. Once the system locates the store with the closest profile, the system searches the set of models for that store for an appropriate model. At step 208, the system 100 will retrieve the appropriate model. In an alternative embodiment, the system 100 may provide the system administrator 136 with the option of choosing a model from those stores with the closest profiles or with the option of overriding the model selected by the system.

After the appropriate model has been retrieved, the system will retrieve the recent transaction data at step 210. Transaction data may include the type of sale (e.g. cash, food stamp, credit card, check, or gift card), the number and identity of items sold, the price of each item, the time at which the transaction occurred and the time required to complete the transaction. In one embodiment, transaction data may include extremely detailed information, such as the type of credit card used. Transaction data may be collected at customer checkout by a point of sale (POS) system. One possible POS system is the BEETLE®/OnePOS, commercially available from Wincor Nixdorf, Inc. of Austin, Tex. As items are scanned by the POS system, information regarding the type, price and number of items is recorded by the POS systems. In one embodiment, the transaction data may be retrieved from the POS system and stored in a transaction log database 102, shown in FIG. 1. The system may import the transaction data from the various databases.

In one embodiment, at step 212, the system 100 may filter the transaction data before updating or creating the sales model. Filters may be used to determine which data qualifies for inclusion or exclusion in a particular model. For example, when updating or creating a model for a Monday at a particular store, the system 100 may automatically filter out data collected on other days of the week. Additionally, the system may also filter out other data such as the data associated with special events including holidays and the like. At step 214, the operator may direct the system 100 to perform additional filtering excluding data to correct for nonscheduled events such as blackouts, blizzards and the like.

At step 216 the system 100 may weight the transaction data prior to updating the sales model to control the impact or the effect of the new data on the model. The weights may be adjusted to control the averaging of the data. For example, if there is a change in store conditions, e.g. the construction on a nearby road, such that historical data from more than a few days ago no longer accurately reflects the store conditions, new transaction data may be heavily weighted so that the model updates quickly to reflect the new conditions. Similarly, when the system is generating a new model, the transaction data may be heavily weighted so that the model quickly adjusts to reflect the conditions of the new store.

Once the transaction data has been properly filtered and weighted, it is combined with the model at step 218 to create a new or updated sales model. The system 100 stores this new or updated model in the system database at step 220. In one embodiment, this process is repeated on a weekly basis for each model for every store in the enterprise.

III. Sales Forecasts

Sales models may be used to generate a sales forecast. As used herein, a sales forecast predicts future sales by departments, individual stores, groups of stores, divisions or the entire enterprise during a specific period of time. In one embodiment, a sales forecast will predict the number and type of transactions, including the quantity and type of items, occuring in fifteen-minute intervals throughout the course of a day. The system may generate sales forecasts by combining sales models, event models and additional user adjustments.

Accurate forecasting of future performance depends on identifying relevant event history and determining the effect, based on past performance, a similar or identical event will have on future performance. Examples include store remodeling, natural disasters, upgrading of a POS system, local area sporting events, special sales events and the like. When forecasting future performance, events determine which historical information or variance parameters should be used in the aggregation and the trending of forecast sales. In a one embodiment, the system information regarding an event should include a start and end date and time, an event name, a description of the event and the store or group of stores affected by the event.

In one embodiment, users may schedule events using a system calendar function. The system calendar may be capable of tracking events such as holidays, remodeling and other events. The system may utilize information on the calendar regarding events that have already occurred to identify and filter out anomalous data when creating models. In addition, the system may use information regarding future, scheduled events to adjust the forecasts to reflect the likely impact of such events.

Event models reflect or simulate the impact of specific events on sales operations. An event model may simply be a sales model generated using only historical transaction data associated with the particular event or it may be an algorithm designed to adjust a sales model to reflect the impact of the event. An event model algorithm may be derived from enterprise knowledge based on experience with similar stores.

In one embodiment, if there is insufficient historical data for the event at the store, the system may utilize an event model algorithm until there is sufficient historical data to generate an event model. The system may include preset minimum history requirements that determine when there is sufficient historical data to generate an event model. Alternatively, a system administrator or user may define the minimum history requirement. For example, the system may require a minimum history of two weeks. If there is no prior data regarding the event for that store, during the first two weeks of the event a standard sales model will be adjusted based upon the event model algorithm. After two weeks, the system will generate an event model based upon the collected data. The event model will then be combined with the sales model or models.

For example, a store is scheduled for remodeling which is predicted to last twelve weeks starting on March 12th. In the past, similar remodels have represented a decrease in sales of 20% for stores with similar demographic profiles. A system user attaches an event to the system calendar that identifies the start date for the event as March 12th and an end date 12 weeks later. When sales forecasts are generated for the end of March, during the remodeling, predicted sales are decreased by 20%. During the 12-week period, the forecast may be adjusted if the actual variation in sales is greater than or less than 20%. Additional examples of events include circulation of coupons, local construction, the beginning of daylight savings time and the like.

Multiple sales and event models may be combined to generate a sales forecast. For example, for a store being remodeled on the last Tuesday of the month, the system may combine the sales model for a Tuesday, the sales model for the last day of the month and the event model for remodeling a store to generate a sales forecast. Each store in the enterprise may have multiple versions of each type of model generated from historical data collected at that store. In one embodiment, the system automatically retrieves all of the appropriate sales and event models required to generate a sales forecast. The system may utilize information from the system calendar to determine the appropriate sales model or models and whether there are any scheduled events. In one embodiment, the system may allow users to dynamically include or exclude models when generating the sales forecast. The users at all levels of the enterprise may be able to generate multiple forecasts using different models. By generating multiple forecasts, reflecting the impact of different events or actions users may be able to optimize the store performance.

IV. Labor Forecast

In one embodiment, the system may also be used to generate labor forecasts that project the labor requirements for a store. In one embodiment, the labor forecast predicts the workforce required for a store in fifteen-minute increments throughout the course of a day. The system may also be used to predict the costs associated with those requirements. The labor forecast may be based upon the sales forecast as well as additional types of models generated from historical data. The types of models utilized to generate the labor forecast may include shipment models, item preparation models, pharmacy models, pricing models, transaction models and the like.

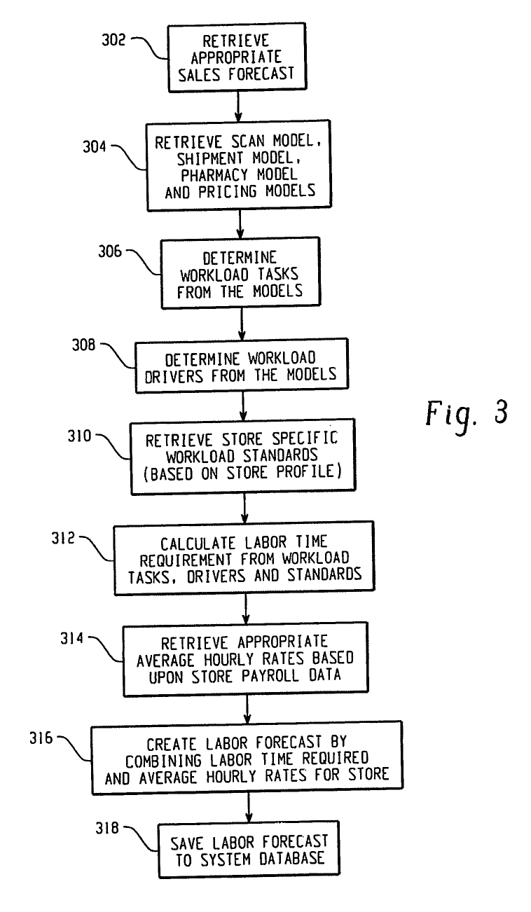

Referring now to FIG. 3, to generate a labor forecast, at step 302 the system first retrieves a sales forecast, which predicts frequency and type of transaction occuring throughout the course of a day. In an embodiment including transaction models, the transaction models corresponding to the sales models used to generate the sales forecast are also retrieved at step 302. At step 304 the system retrieves additional models that simulate store conditions, such as the shipment model, item preparation model, pharmacy model and pricing model. Each of these models contains information regarding the workload tasks which are predicted to take place within the store during a given time period. A workload task, as used herein, is a task or job to be accomplished. In one embodiment, the system may automatically generate or updates a sales forecast, shipment model, item preparation model, pharmacy model, pricing model and transaction model on a weekly basis and stores these models and forecasts, so that they can be retrieved and utilized to generate the labor forecast.

At step 306, the system retrieves the workload tasks that will have to be performed within the store during the modeled time period. Workload tasks which remain constant regardless of volume or type of sales may be stored and retrieved from a database. Workload tasks dependent on sales may be generated from the models. Examples of workload tasks include, but are not limited to, scanning items during a transaction, stocking shelves, cutting meat, baking bread and the like. In one embodiment, the system maintains a schedule or list of standard workload tasks for each store. The system is able to schedule common workload tasks, setting days or times when the task must be accomplished. The system saves information regarding each workload task including the name of the task, a list of days and time windows when a task must be performed, as well as the frequency with which the task must be performed. Workload task information may well be store or division specific. Each department or division within the enterprise may have different stocking methods. In addition, stores may have different equipment available for their departments.

At step 308, the system retrieves workload driver information from the models and the sales forecast. A workload driver is a unit of work necessary in completing a workload task. For example, one of the workload drivers associated with the workload task of stocking shelves may be the number of items to be stocked. Examples of workload drivers include, but are not limited to, case counts, customer counts, delivery counts, price change counts, price verification, sales, method of payment, coupons, scanned items, special cashier transactions such as looking up items, weighing operations, refunds, voids, debits, credits, and overrides.

Workload drivers may be associated with multiple workload tasks. For example, the workload driver case count may be used to calculate the labor requirements for the workload task of stocking the shelves. The workload driver case count would also be used to determine labor requirements for the transport workload task, where transport refers to the task of getting the produce or items from a storage area to the display floor of the store.

Multiple workload drivers, comprising a workload driver set, may be associated with a single workload task. In such a case, workload driver set is a named list of workload drivers that, when grouped together, represent the composite factors necessary for determining the workload, or labor required to complete a task. For example, a meat cutter may process many different types of meats, each having different workload drivers. A summation of these elements constitutes a workload driver set. In one embodiment, the system will include a database containing information associating workload drivers and workload driver sets with workload tasks.

At step 310, the system generates the workload standards to be used for the store. A workload standard, as used herein, is the amount of time attributable to each workload driver. Workload standards are created by analyzing the time and performance of the tasks. One method of developing workload standards includes videotaping workers performing the tasks to determine a standard or average amount performance time, which is then used as the workload standard.

In one embodiment, each store will have a different set of workload standards due to the differences in the physical attributes of the stores, such as square footage, number and location of departments, as well as the equipment available. The system is able to retrieve information regarding the physical attributes of the store from the facilities database 116, as shown in FIG. 1B. For example, a workload driver, such as cases, will be utilized for many different types of stores. However, because of differences between stocking whole cases and individual items, the time or workload standard associated with stocking a case in a warehouse type of store will vary greatly from the time required to stock a case in a convenience store.

At step 312, the system combines the information regarding workload drivers, workload standards and workload tasks to generate a forecast of the labor required during the course of a day. For each workload task, the system pulls the associated workload drivers from the models and the sales forecast. Workload standards may be applied against the workload drivers to forecast the labor requirements for completing a workload task. As discussed above, workload tasks may be scheduled throughout the day. Therefore, the system is able to predict the amount of labor required throughout the course of the day.

At step 314, in one embodiment, the system retrieves specific payroll information from the payroll database 122, shown in FIG. 1, for the store. The system uses a store specific average hourly rate, calculated from payroll information for that store. In one embodiment, the system will calculate, by store and by department, an average rate of pay based on historical and trend analysis. At step 316, the system may create a budget and labor forecast for the store by combining the information regarding the labor requirements and the payroll information. At step 318, the labor forecast may be stored in a system database.

V. Enterprise Creation of Sales and Labor Forecasts

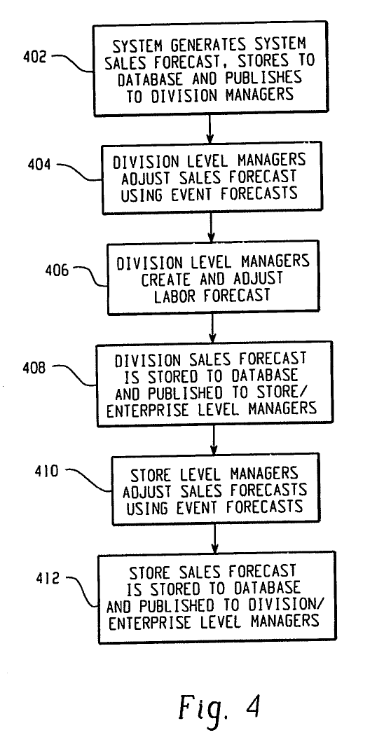

Referring now to FIG. 4, in one embodiment, the system may be used to periodically generate and distribute sales and labor forecasts, allowing management at all levels of the enterprise to adjust and compare the forecasts. Beginning at step 402, the system generates sales forecasts based upon the day of the week, the proximity to the beginning or end of the month and any scheduled events. In one embodiment, the system will generate a sales forecast for each store in the enterprise. These system generated sales forecasts are distributed to the appropriate division level managers and saved by the system.

At step 404, the division level managers may adjust the sales forecast by selecting additional event models. The division level managers may generate multiple forecasts until they are satisfied with the predicted performance. At step 406, the division level managers may utilize the system to create and update labor forecasts based in part upon the sales forecasts. At step 408, the forecasts are stored on the system and transmitted to enterprise level and store level management.

At step 410, store level managers may make additional adjustments to the sales or labor forecast by selecting additional event models to be included. At step 412, once the store manager is satisfied with the sales and labor forecast, it is saved by the system and transmitted to the division and enterprise level management for any further adjustments. If approved, the sales and labor forecasts will be finalized and saved as the budget for the forecast period.

In one embodiment, once the labor forecast is finalized and the budget is set, the labor forecast information may be imported into labor scheduling software and used to generate a worker schedule. Using the information regarding the labor requirements broken down by department in small time intervals through out the day, workers can be scheduled to efficiently handle the necessary workload.

VI. Labor Management System Benefits

A. Planning

The preceding description of the forecasting process focused primarily on generating forecasts for individual stores. However, the system may compile and merge forecasts from individual stores to generate a combined forecast for a group of stores. These combined forecasts may be generated for a list of stores as defined by a user, or they may be generated for predetermined groups of stores, such as divisions, zones or even the entire enterprise. In one embodiment, the system may be able to compile information regarding individual departments within the stores. For example, a division level manager may wish to view sales and labor forecasts for the deli department for all stores within a division. Combining information from multiple stores assists upper level management in predicting and planning for performance of a division or enterprise.

The system may be used as a planning tool at all levels of the enterprise, allowing enterprise, division and store level managers to predict the effects of various events on sales and labor costs. Managers may generate multiple scenarios simulating various courses of actions. As used herein, a scenario is a sales forecast, labor forecast or budget generated for a particular course of action or set of events. The system may be used to compare the results of different scenarios and assist the manager in selecting the optimal course of action. For example, a store level manager may use the system to predict the effects of a promotional event, such as a special price reduction. By generating two scenarios, one in which the price reduction is applied and one in which the price reduction is not implemented, the system may predict the difference in sales and labor costs and assist the manager in determining whether to apply the price reduction. In one embodiment, the system will allow users at all levels to generate alternative scenarios, increasing the total number of scenarios evaluated and optimizing store planning.

The system may also be used by management to set enterprise, division, zone or store goals. In one embodiment the system is able to automatically allocate goals to lower levels of the store hierarchy. For example, an enterprise wide goal would be divided or allocated to the various divisions, zones, stores and departments that make up the enterprise. This process is known as proration. In order to perform proper proration, the system must understand the subset, hierarchies and rules that define the enterprise and are established by the users. As discussed above, the system is able to import information regarding the enterprise hierarchy from the organizational hierarchy database 114, as shown in FIG. 1B. For example, division management may require an increase in the division meat sales by $250,000 for a week. Sales do not occur at the division level, so the increase must be spread proportionately to each of the stores within the division. The system automatically determines the projected proportionate contribution of each store in meat sales and distributes the amount accordingly.

B. Report Generation

In one embodiment, the system allows data to be combined and summarized in high level reports and also allows users to drill down into the underlying data to the details. Reports may be reflect the information at the enterprise level and allow users to elect to view more detailed information using a standard hierarchy of information, e.g. division, zone and store. In an alternative embodiment, the system may provide users with the ability to determine the hierarchy of the information. For example, a user may need to access department totals at the division level. The system may allow the user to change the information hierarchy to division, department and store.

The system may be used to compare projected sales and labor with actual occurrences. For example, a comparison may be made between the budgeted weekly department sales and actual weekly department sales. If the budgeted sales for meat is $150,000 and the actual sales are $150,100, there is little cause for concern. However, if the actual sales were only $100,000, the variance of $50,000 may be important and could be used to trigger an alert. As used herein, an alert may be a highlighted line on a weekly report. In an alternative embodiment, an alert may be a message or notice, such as an email, sent to specific users. In one embodiment, the user may establish certain acceptable limits, or deviations from the forecast. Data outside of those limits would automatically generate an alert. In an alternative embodiment, the system may determine when an alert should be generated based upon statistical probability. Variance reporting takes the results of a comparison and notes what is outside specified deviations. Algorithms can be used to determine a standard deviation. Data that exceeds the standard deviation may be flagged in a report.

The system may include the ability to filter data before inclusion in reports. For example, a division manager may wish to view existing quarterly budgets of stores in the Carolinas. Filtering gives the user the ability to select the budgets or scenarios to examine and to specify the stores they want to include. Filtering first by quarterly budgets will return the quarterly budget in all stores in the division. A second filter, state, limits the search results to stores located in North Carolina or South Carolina.

In one embodiment, the system includes a flexible graphical user interface (GUI) that allows the user to customize forms and reports to meet their needs. The system may individual security codes and login information to allow users to save and reuse customized views.

VII. System Architecture

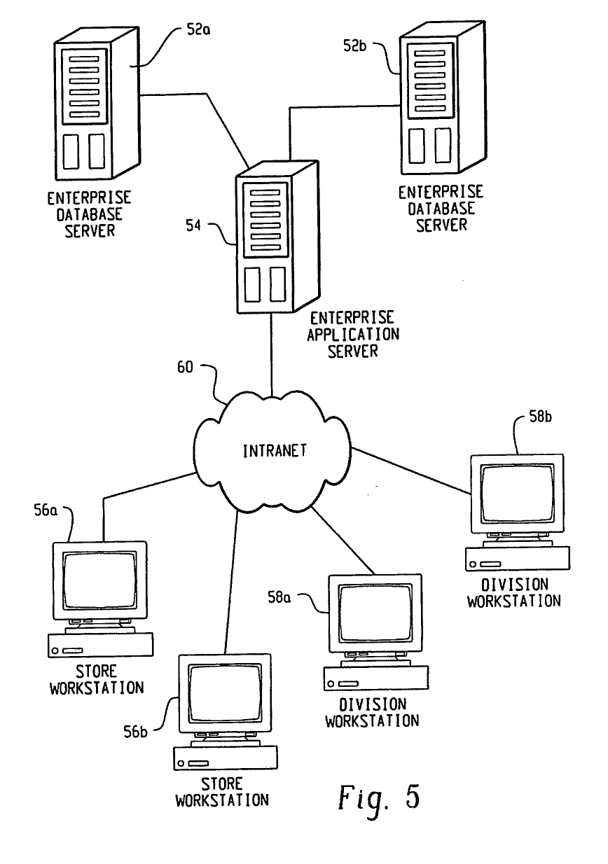

Referring now to FIG. 5, one embodiment of the invention utilizes a relational database, such as DB2 Universal Database V8.1 commercially available from IBM, to save models and forecasts on multiple enterprise level database servers 52a and 52b. The enterprise level database servers 52a and 52b may be connected to the enterprise level application server 54 via a Local Area Network (LAN) or a wide area network (WAN). The enterprise level servers may be implemented with an IBM eserver p690, also known as the regatta server, commercially available from International Business Machine Corporation (IBM) of Armonk, N.Y. Workstations located at individual stores 56a and 56b or at the offices of the division level managers 58a and 58b may be connected to the enterprise level application server 54 via an intranet 60, the Internet, an extranet or some other network. The workstations 56a, 56b, 58a and 58b may be implemented using personal computers having processors, memory, communication interfaces and suitable input/output devices such as a mouse and keyboard. For example, the workstations 56a, 56b, 58a and 58b may be implemented using the Think Centre™ A30, commercially available from IBM. Workstations 56a, 56b, 58a and 58b, as used herein, may also include digital systems and other devices permitting connection to and navigation of the network. The system is sufficiently flexible in its design to permit implementation in various computer systems and networks and is not limited to the system architecture described above.

The system includes a GUI located on the enterprise level application server 54, which may be accessed from the store and division workstations 56a, 56b, 58a and 58b. A number of the functions of the system may be applicable only to certain levels of the enterprise. For example, only enterprise personnel should have access to define workload standards, create and view enterprise level budgets and perform system maintenance. In one embodiment the system will limit the available functions based upon the user.

While particular embodiments of the present invention have been illustrated and described, it would be obvious to those skilled in the art that various additional changes and modifications can be made without departing from the spirit and scope of the present invention. While the workload tasks, departments and the like have been shown illustrative of a grocery store, certainly those of skill in the art can apply these principles to stores, factories, service industries and warehouses of various types. For example, in a department store workload tasks may include arranging displays, steaming clothes, clearing dressing rooms and the like. In a fast food restaurant workload tasks may include clearing tables, making sandwiches, cooking various foods and the like. It is therefore intended to cover in the appended claims all such changes and modifications that are within the scope of this invention.

What is claimed:

1. A method for generating labor requirements comprising the steps of:
providing a plurality of sales models based upon historical data, where each sales model is associated with a store within an enterprise;
selecting a sales model;
generating a sales forecast for a store based upon the selection of at least one sales model;
obtaining workload standards;
obtaining labor rates; and
generating a labor forecast for the store based upon the sales forecast, the workload standards and the labor rates;
where a store level user is capable of generating labor requirements.

2. The method for generating labor requirements according to claim 1, wherein the sales forecast for a store is based on at least one sales model associated with another store.

3. The method for generating labor requirements according to claim 1, wherein the historical data is smoothed, averaged, weighted or a combination thereof to generate the plurality of sales models;

4. The method for generating labor requirements according to claim 1, further comprising the steps of providing a plurality of event models based upon historical data associated with an event and selecting an event model, wherein the selection of at least one event model is utilized in the creation of the sales forecast.

5. The method for generating labor requirements according to claim 4, wherein the historical data is smoothed, averaged, weighted or a combination thereof to generate the plurality of event models.

6. The method for generating labor requirements according to claim 1, further comprising the step of importing the labor forecast into a labor scheduling system to generate a schedule for workers.

7. The method for generating labor requirements according to claim 1, further comprising the step of generating the labor rate from payroll information.

8. The method for generating labor requirements according to claim 1, further comprising the step of collecting actual sales and actual labor costs from the store.

9. The method for generating labor requirements according to claim 8, further comprising the step of comparing the sales forecast to actual sales.

10. The method for generating labor requirements according to claim 8, further comprising the step of comparing the labor forecast to actual labor costs.

11. The method for generating labor requirements according to claim 9, further comprising the step of generating a notice when actual sales vary from the sales forecast by more than about 10%.

12. The method for generating labor requirements according to claim 10, further comprising the step of generating a notice when actual labor costs vary from the labor forecast by more than about 10%.

13. The method for generating labor requirements according to claim 1, further comprising the step of filtering the historical data.

14. The method for generating labor requirements according to claim 1, further comprising the step of generating a shipment model describing delivery of items to the store, wherein the shipment model is utilized in generating the labor forecast.

15. The method for generating labor requirements according to claim 1, further comprising the step of generating a tag model describing tags created or modified for the items in the store, wherein the tag model is utilized in generating the labor forecast.

16. The method for generating labor requirements according to claim 1, further comprising the step of generating a preparation model describing preparation for certain items in the store, wherein the preparation model is utilized in generating the labor forecast.

17. The method for generating labor requirements according to claim 1, further comprising the step of generating a pharmacy model describing pharmacy tasks, wherein the pharmacy model is utilized in generating the labor forecast.

18. The method for generating labor requirements according to claim 1, further including the step of selecting a transaction model corresponding to the selected sales model wherein the labor forecast is generated based upon the selected transaction model.

19. A system for generating labor requirements comprising:
an application server;
a database server including a plurality of sales models based upon historical data, where each sales model is associated with a store within an enterprise;
at least one workstation;
wherein the application server is programmed to perform the steps of:
selecting a sales model from the plurality of sales models;
generating a sales forecast for a store based upon the selection of at least one sales model;
obtaining workload standards;
obtaining labor rates; and
generating a labor forecast for the store based upon the sales forecast, the workload standards and the labor rates;
where a store level user at the workstation is capable of generating labor requirements.

20. The system of claim 19, wherein the database server includes a plurality of event models based upon historical data associated with an event and where at least one event model is utilized in the creation of the sales forecast.
